(19) United States
(12) Patent Application Publication
(10) Pub. No.: US 2024/0329635 A1
(43) Pub. Date: Oct. 3, 2024

(54) THE MODELING EVOLUTIONARY METHOD AND CONCERNING DEVICE OF TUNNEL VISION GUIDANCE SYSTEMS BASED ON OPTICAL ATTRIBUTES

(71) Applicant: China Academy of Transportation Sciences, Beijing (CN)

(72) Inventors: Zhaohui Wu, Beijing (CN); Zhiqiang Fu, Beijing (CN); Xiantong Li, Beijing (CN); Ziyi Lv, Beijing (CN); Dianliang Xiao, Beijing (CN)

(21) Appl. No.: 18/460,702

(22) Filed: Sep. 5, 2023

(30) Foreign Application Priority Data
Mar. 27, 2023 (CN) 2023103056440

(51) Int. Cl. G05D 1/00; G05D 1/02

(52) U.S. Cl. CPC G05D 1/0094

(57) ABSTRACT

The invention discloses a modeling and evolution method and concerning device of tunnel vision guidance systems based on optical attributes, which involves the sector of traffic information technology. The invention comprises obtaining the entity elements of tunnel visual guidance systems and the optical attribute information of each type of entity elements, according to the geometric parameters of the entity elements, establishing the BIM parametric geometric model of the entity elements, further combined with optical attribute information of entity elements, constructing the target BIM parametric geometry model library, as well as adjusting model parameters based on the target BIM parameterized geometric model library to realize the dynamic evolution of tunnel vision guidance systems. The invention aims to build a tunnel vision guidance entity element model combining geometric model and optical properties, which considers the influence of visual factors on traffic participants, and improves the accuracy of simulation inference results.

### TECHNICAL FIELD

The disclosure relates to the field of traffic information technology, in particular to the method and device for modeling and evolving a tunnel vision guidance system based on optical attributes.

### BACKGROUND

At present, the model construction of a tunnel visual guidance system is realized only through geometric modeling, and does not consider the impact of light source and reflective sign. However, the increasingly complex road network and driving conditions make it difficult for traffic participants to quickly and accurately obtain road information and understand traffic management instructions.

Therefore, in order to reduce the impact of visual guidance such as light source and reflective sign on traffic participants in tunnel models, it is vital to build a tunnel visual guidance entity element model combining geometric model and optical attributes to consider the influence of visual factors on traffic participants and improve the accuracy of simulation and simulation deduction results.

### SUMMARY

The invention has provided a modeling and evolution method and concerning device for tunnel vision guidance systems based on optical properties, which can solve the problem that the available technology does not consider the influence of light source and reflective sign on tunnel vision guidance systems, resulting in inaccurate simulation and its deduction results.

In order to solve the above technical problem, on the one hand, the disclosure discloses an implementation method of an evolutionary method for modeling a tunnel vision guidance system based on optical properties, the method includes: obtain entity elements of the tunnel visual guidance system and the optical attribute information of each type of entity elements; and construct a BIM parameterized geometric model of the entity elements; then, construct a target BIM parameterized geometric model library with optical attributes; and adjust the model parameters of the target BIM parameterized geometric model library to realize the dynamic evolution of tunnel vision guidance systems.

The entity elements of the tunnel visual guidance system and the optical attribute information of each type of entity elements are obtained, where the types of the entity elements include light source and indication signs; The optical property information includes the type, brightness, color, display content and display degree of light source.

According to the geometric parameters of the entity elements, the BIM parameterized geometric model of the entity elements is constructed. The geometric parameter includes the contour information of the entity element.

Based on the BIM parameterized geometric model and the optical attribute information of each type of entity elements, a target BIM parameterized geometric model library with optical attributes is constructed.

Model parameters are adjusted based on the target BIM parametric geometric model library to realize the dynamic evolution of tunnel vision guidance systems, which are determined based on the geometric parameters and optical property information of each type of entity elements.

According to the second aspect of the disclosure, a concerning modeling and evolution device for tunnel vision guidance systems based on optical properties is provided, and the system includes: the information acquisition module, the BIM parametric geometric model building module, the building module of the target BIM parameterized geometric model and the building module of the target BIM parameterized geometric model.

The information acquisition module is used to obtain the entity elements of the tunnel visual guidance system and the optical attribute information, where the types of the entity elements comprise light source and indication signs; The optical property information includes the type, brightness, color, display content and display degree of light source.

The BIM parametric geometric model building module is used to build the BIM parametric geometric model of the entity elements according to the geometric parameters of the entity elements; The geometric parameter includes the contour information of the entity element.

The building module of the target BIM parameterized geometric model library is used to build the target BIM parameterized geometric model library with optical properties based on the BIM parameterized geometric model and combined with the optical property information of each type of entity element.

The dynamic evolution module is used to adjust the model parameters based on the target BIM parametric geometric model library, so as to realize the dynamic evolution of the tunnel vision guidance system; The model parameters are determined based on the geometric parameters and optical property information of each type of entity elements.

Compared with the related art, the beneficial effects of the disclosure are as follows.

The disclosure provides a modeling and evolution method of tunnel vision guidance systems based on optical properties to obtain the entity elements of the tunnel vision guidance system and the optical property information of each type of entity elements. According to the geometric parameters of the entity elements, the BIM parametric geometric model of the entity elements is constructed. Amid the construction of the BIM parametric geometric model corresponding to each type of entity elements, the optical attribute information of each type of elements is added, so that the geometric model of each type of entity elements can be combined with the optical attribute information to obtain the BIM parametric geometric model with optical attributes. Optical factors such as the influence of light source and reflective sign on traffic participants can be taken into account in the tunnel entity element model; In addition, each type of entity elements can be assigned on the BIM parametric geometric model with optical attributes, the BIM parametric geometric model can be updated by making use of model parameters, the standardized model corresponding to the entity of each type of entity elements can be obtained, and then the standardized model corresponding to each type of entity elements can be processed. The target BIM parametric geometric model library with optical properties can be obtained and through adjusting model parameters in target BIM parametric geometric model library, it is doable to realize the dynamic evolution of tunnel visual guidance systems, accelerate modeling, and improve the accuracy of simulation and its deduction results.

### BRIEF DESCRIPTION OF DRAWINGS

FIG. 1 provides a flow chart of the tunnel vision guidance system modeling and evolution method based on optical properties.

FIG. 2 provides a schematic diagram of the modeling evolution implementation steps of a tunnel vision guidance system based on optical attributes.

FIG. 3 provides an entity element classification diagram of tunnel vision guidance systems based on optical attributes.

FIG. 4 provides an optical properties-based dynamic evolution diagram of tunnel vision guidance systems.

FIG. 5 is a structural schematic diagram of the tunnel vision guidance system modeling and evolution device based on optical properties.

### DETAILED DESCRIPTION OF EMBODIMENTS

In order to facilitate the clear description of the technical scheme of the embodiment of the invention, the words “first” and “second” are adopted in the embodiment of the invention to distinguish the same or similar items with basically the same function. For example, the first threshold and the second threshold are only used to distinguish different thresholds and do not limit their order. Those skilled in the field may understand that the words “first” and “second” do not limit the quantity and order of implementation, also they are not necessarily different.

It should be noted that in the invention, the words “exemplary” or “for example” are used to mean as an example or illustration. Any embodiment or design described in the invention as “exemplary” or “for example” shall not be construed as preferable or superior to other embodiment or designs. Rather, the use of words such as “exemplary” or “for example” is intended to present the concept in a concrete way.

In the invention, “at least one” means one or more, and “multiple” means two or more than two. “And/or” describes the association relationship of associated objects, indicating that there can be three kinds of relations, for example, A and/or B, can represent A exists alone, A and B exist simultaneously, and B exists alone, where A and B can be singular or plural. The character “/” generally indicates that the associated object is an optional relationship. “At least one of the following”, or similar expressions thereof, means any combination of such terms, including any combination of single or multiple terms, for example, at least one term (a) in a, b, or c can be expressed as a, b, c, the combination of a and b, the combination of a and c, the combination of b and c, or the combination of a, b and c, where a, b, c can be single or multiple.

### Embodiment 1

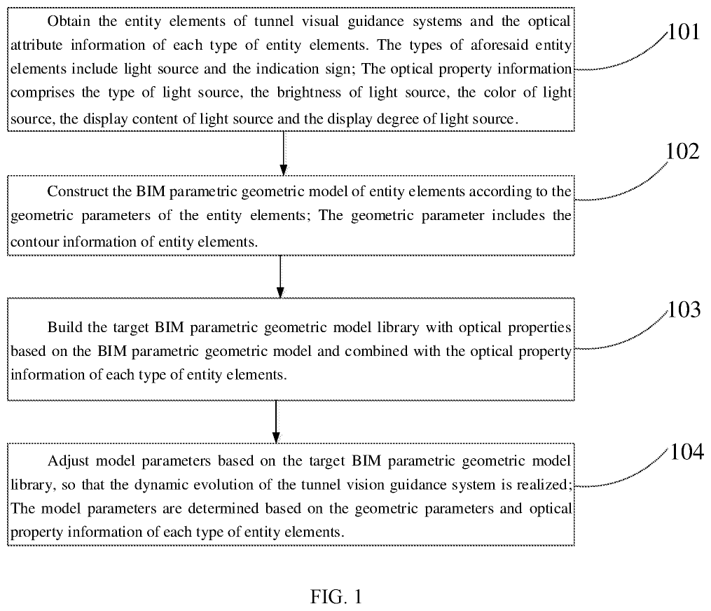

FIG. 1 provides a flow chart of an evolutionary method for modeling a tunnel vision guidance system based on optical properties, which comprises the following steps:

101. Obtain the entity elements of the tunnel visual guidance system and the optical property information of each type of entity elements. The types of the entity elements include light source and indication mark; The optical property information includes the type, brightness, color, display content and display degree of light source.

102. According to the geometric parameters of the entity elements, build the BIM parametric geometric model of the entity elements; The geometric parameter includes the contour information of the entity element; Construct BIM parametric geometric model.

Among them, parametric modeling is a computer-aided design method and an important process of parametric design. In a parametric modeling environment, parts are composed of features. Ones can be made up of either positive or negative space, where a positive space feature is a block that actually exists (for example, a protruding boss), and a negative space feature refers to what is excised or subtracted (for example, a hole).

BIM (Building Information Modeling, abbreviated as BIM), is a model-based technology that can be linked with building database. As a composite model that associates parameters with behaviors, BIM parametric modeling can intuitively show buildings. By creating and modifying the parameters of component geometry, material, general information, etc., accurate models are obtained, and data analysis such as spatial analysis, dynamic analysis and other model analysis is performed; In addition, the assignment to associated parameters enables virtual simulation of real-world behavior.

BIM software can do parametric modeling, such as Bentley's parametric graphics software MicroStation, three-dimensional bridge modeling software OpenBridge Modeler, road design software OpenRoads Designer, multi-professional architectural design software OpenBuildlings Designer.

Contour information refers to the shape, length and width of the object corresponding to the entity elements, such as the circle of lighting lamps and traffic lights, the diameter and thickness of the lamps, and the length, width and height of the rectangular lamps; The shape of road marking (e.g., strip marking, arrows, arcs, semicircles) and the length, width, etc., of each type of marking shape; The shape of reflective signs, electro-optical signs, variable information signs, variable speed limit signs, lane indicators (including rectangular, circular, oval, and other shapes) and the length and width of each type of shape.

103. Based on the BIM parameterized geometric model and combined with the optical property information of each type of entity elements, a target BIM parameterized geometric model library with optical properties is constructed.

Among them, the model library is to organize a large number of models according to a certain structural form, and carry out effective management and use of each model through the management system of the model library. The model library in Step 103 can contain multiple BIM parametric geometric models with multiple optical properties.

104. Model parameters are adjusted based on the target BIM parametric geometric model library to realize the dynamic evolution of tunnel vision guidance systems; The model parameters are determined based on the geometric parameters and optical property information of each type of entity elements.

The dynamic evolution of the model refers to the updating of its function and architecture during the operation of the model, which is generally changed with the changes of relevant parameters, may involve time factors, and has dynamic properties. Through the above steps, the dynamic simulation evolution of the real tunnel vision guidance system can be carried out by adjusting the model parameters.

### Embodiment 2

As an optional embodiment, when building the BIM parameterized geometric model of the entity elements according to the geometric parameters of the entity elements, the parameters of each type of entity elements are obtained with the type of entity elements as the dimension, as shown in FIG. 3. The type of the entity elements includes lighting lamps and traffic lights; Indication signs in the type of entity elements include road marking, reflective signs, electro-optical signs, variable information signs, variable speed limit signs and lane indicators; According to the type of the entity elements and the geometric parameters of the entity elements, a BIM parametric geometric model corresponding to each type of entity elements is constructed.

Among them, the lighting lamps can be all kinds of lighting lampss in the tunnel, including basic lighting, enhanced lighting, emergency lighting, etc.; Road marking may be road markings, contour signs, guidance signs and protruding road signs with reflective coatings in the tunnel; Reflective signs can be tunnel signs, no overtaking signs, height limit signs, etc., using reflective paint in the tunnel; The electro-optical signs can be an emergency telephone indicator sign, fire hydrant indicator sign, pedestrian crosswalk indicator, driving crossing indicator sign, emergency parking belt sign, evacuation indication sign, etc., which uses internal or external lighting in the tunnel; The variable information sign can be a traffic sign composed of LED used to display variable information such as road condition, traffic condition and climate condition in the tunnel; The variable speed limit sign can be a sign composed of LED for displaying road speed limit information in the tunnel, and the speed limit value can be changed; The lane indicator can be an indicator composed of LED used to indicate the use of the lane at the tunnel entrance, usually square, and the same indicator supports two types of changes: Red Cross and Green Arrow; The traffic lights can be traffic lights in tunnels composed of LED, including red, yellow and green lights, turning left arrow lights, etc.

### Embodiment 3

As an optional embodiment, model parameters are determined based on geometric parameters and optical property information for each type of entity elements, including:

Determine the model parameters of the light source in the type of entity elements, including the model parameters of the lighting lamps and the model parameters of the traffic lights.

Determine the model parameters of the indication sign in the type of the entity element, including the model parameters of the road marking, the model parameters of the reflective sign, the model parameters of the electro-optical sign, the model parameters of the variable information sign, the model parameters of variable speed limit sign and the model parameters of lane indicator.

The model parameters of the lighting lamps include the shape, contour size, type, luminous flux, luminous efficiency, color rendering index, color temperature interval, theoretical life and dimming parameters of the lighting lamps.

The model parameters of traffic lights include the radius, luminous flux, display color, dimming coefficient and display content of the traffic light.

The road marking model parameters include the shape, contour size, type, color, reflective film type, minimum reverse reflection coefficient, daytime color and night color of road marking.

The model parameters of the reflective sign include the shape, contour size, type, color, reflective film type, minimum reverse reflection coefficient, daytime color, night color and typical texture of reflective signs.

The model parameters of the electro-optical sign include the shape, contour size, type, illumination type, luminous flux, color rendering index, color temperature interval, dimming parameters and typical texture of electro-optical signs.

The model parameters of the variable information sign include the shape, contour size, luminous flux, color rendering index, color temperature interval, dimming parameter and text content of the variable information sign.

The model parameters of the variable speed limit sign include the shape, contour, luminous flux, color rendering index, color temperature interval, dimming parameter and speed limit value of the variable speed limit sign.

The model parameters of the lane indicator include the rectangular side length, the LED luminous flux, the number of LEDs on each side, the traffic state and the dimming coefficient of the lane indicator.

Among them, the shape of the lighting lamps is used to describe the geometry of the light source range, including circle, rectangle and other types; The contour size is used to describe the geometric size of the light source range. According to the shape of light source, the corresponding geometric size is selected, where for round lamps, it is the diameter and thickness of the luminous surface; for rectangular lamps, it is the length, width and height of the luminous surface; while for lamps in other shapes, the scalability is reserved. Luminous flux is used to describe the sum of the amount of visible light emitted by light source per second, in lumens (lm). Luminous efficiency is used to describe the luminous efficiency of light source, that is, the ratio of the light energy emitted by the light source divided by its power consumption, in lumens/watts (lm/w). The color rendering index is used to describe the color rendering of the light source, that is, the degree to which the light source shines on the object and renders the color of the object. The higher the color rendering, the better the performance of the light source on the color, the closer the observed color is to the natural color, and the value range can be [0,100]. The color temperature range is used to describe the color of the light source. The unit is Kelvin (K), and the value range can be [1000,10000]. Theoretical life is to explain the theoretical life of lighting lamps, in hours (h). The dimming parameter indicates whether the light source is adjustable. The value range is [0,1], where 0 indicates the light source is fully dark, and 1 indicates that the light source is fully bright. For non-adjustable light source, it is often assigned 1.

The radius of a traffic light is used to describe the geometric size of a single signal light. Luminous flux is used to describe the maximum luminous intensity of a signal lamp as light source. The display color is used to describe the display color of the signal light. The same signal light should support the change of red, yellow, and green. The dimming coefficient is used to describe the adjustability of the light intensity. Display content describes the non-traffic light content displayed by traffic lights.

The shape of the road marking is used to describe belt markings, arrows, arcs, semicircles and other shapes; The contour size is used to select the corresponding geometric size for each type of marking shape to reserve scalability. The type is used to describe road marking, contour signs, guidance signs and protruding road signs. The color is used to describe the color of the marking line. The type of reflective film is used to describe various types such as glass bead type and micro-prism type. The minimum inverse reflection coefficient is used to express the luminosity performance of the reflective sign, which is related to the observation Angle and the incidence Angle, and its value can be obtained by looking up the table. Daytime color is used to describe the color of the reflective film during the day, and the value range can be obtained by checking the color coordinate table and color diagram of the reflective film. Night color is used to describe the color of the reflective film at night, and the value range can be obtained by checking the color coordinate table and color diagram of the reflective film.

Reflective sign type is used to indicate the type of the signs, including tunnel sign, no overtaking sign, height limit sign, and so on. Typical textures are used to describe the content of complex signs and are stored in picture format. Other parameters are defined in accordance with the corresponding parameters of road marking.

The shape of the electro-optical sign is used to describe the shape of the electro-optical sign, including rectangle, round, oval, and other shapes. Contour size is used to describe the geometric modeling size of the signs in different shapes; The type is used to describe the emergency telephone indicator sign, fire hydrant indicator sign, pedestrian crosswalk indicator sign, traffic crossing indicator sign, emergency parking belt sign and evacuation indication sign, etc. Lighting type describes the type of lighting for electro-optical signs, including internal lighting or external lighting; Typical textures are used to describe the content of complex signs and are stored in picture format. Other parameters are consistent with the corresponding parameters of the lighting lamps.

The shape of the variable information sign is used to describe the overall shape of the variable information sign, including: circle, rectangle, oval, and other shapes; Contour size is used to describe the geometric modeling size of signs in various shapes; Text content is used to describe the text content displayed in the variable message signs, which supports text content changes.

The speed limit value of the variable speed limit sign describes the value of the speed limit and supports the change of the value. Other parameters are defined the same as those of the variable information sign.

The rectangular side length of the lane indicator is used to describe the side length of the square lane indicator. LED luminous flux is used to describe the luminous flux of a single LED on the lane indicator; The number of LEDs on each side is used to describe the number of LEDs on each side; Traffic status is used to describe the content of the lane indicator, including two modes of traffic and no traffic, corresponding to the Red Cross, and green arrow, respectively; Dimming factor describes the adjustability of the brightness of the lane indicator.

### Embodiment 4

As an optional embodiment, a library of the target BIM parametric geometric model with optical attributes is constructed based on the BIM parametric geometric model combined with the optical attribute information for each class of entity elements, including:

For each type of entity element, the corresponding optical attribute information is determined. The optical property information of each type of elements should be added to the BIM parametric geometric model corresponding to each type of entity elements completed. Based on the BIM parametric geometric model with optical properties, a standardized model corresponding to each type of entity elements is constructed. The standardized models corresponding to each type of entity element are processed to obtain the target BIM parameterized geometric model library with optical properties.

The optical attribute information of each type of entity elements is added to the BIM parametric geometric model corresponding to each type of entity element, so that the geometric model of each type of entity elements and the optical attribute information can be combined to make the data in the tunnel entity element model more comprehensive, and the impact of optical factors in the tunnel entity element model on the vision of traffic participants can be taken into account, which addresses the separation of geometric model and optical attribute in the entity element modeling of tunnel vision guidance system, and makes up for the deficiency that the model construction of tunnel vision guidance system in the existing technology is only realized by geometric modeling.

Moreover, a target BIM parameterized geometric model library with optical properties is provided. When the information in the model library is needed, each model can be effectively managed and used directly through the management system of the model library, which greatly improves the efficiency.

### Embodiment 5

As an optional embodiment, a standardized model corresponding to each class of entity elements is constructed on the basis of a BIM parametric geometric model with optical properties, including:

Each type of entity element is assigned. After the assignment, the BIM parameterized geometric model is updated by the model parameters, and the standardized model corresponding to the entity of each type of entity elements is obtained.

Through the assignment to each type of entity elements, the object, geometric parameters and optical attribute information corresponding to the entity elements are determined, a preliminary model is created, and then the BIM parametric geometric model is updated according to the adjustment of the model parameters to obtain the standardized model of the required entities.

### Embodiment 6

As an optional embodiment, the standardized models corresponding to each class of entity elements are processed to obtain a library of the target BIM parameterized geometric models with optical properties, including:

Semantic description is added to each standardized model to obtain a preliminary model library. The preliminary model library is coded and performed data organization, and the target BIM parameterized geometric model library with semantic information and optical attribute information is constructed.

### Embodiment 7

As an optional embodiment, model parameters are adjusted based on the target BIM parameterized geometric model library to achieve the dynamic evolution of the tunnel visual guidance system, including:

The modeling parameters of the visual guidance system in the real tunnel are obtained. The modeling parameters at least include the type of entity element, the location of entity element and the quantity of entity element; Based on the modeling parameters, a three-dimensional tunnel model is constructed. Based on the adjustment of model parameters in the target BIM parametric geometric model library, the dynamic evolution of tunnel vision guidance systems is realized in the three-dimensional tunnel model.

The element type, location, quantity and key modeling parameters of the visual guidance system in the real tunnel to be modeled are collected to obtain the modeling parameters of the visual guidance system in the real tunnel, and the three-dimensional tunnel model of the visual guidance system in the real tunnel to be modeled is constructed based on the modeling parameters. The dynamic evolution of tunnel vision guidance system is realized based on the adjustment of model parameters in the three-dimensional tunnel model.

As long as the model parameters are adjusted in the model library, the element objects can be dynamically changed with the changes of the model parameters, and the rapid construction and dynamic evolution of the tunnel vision guidance system driven by optical attribute data in the virtual scene can be realized.

### Embodiment 8

As an optional embodiment, a three-dimensional tunnel model is constructed based on the modeling parameters, including:

BIM modeling tool is used to construct the main structure of the tunnel based on modeling parameters. At the corresponding position of the main structure of the tunnel, the BIM model corresponding to the entity elements of all the visual guidance system in the tunnel is constructed. BIM models corresponding to all entity elements in the visual guidance system in the tunnel are integrated in the BIM modeling tool to form a three-dimensional tunnel model that can be imported into the graphics development engine.

The BIM modeling tool is used to build the main structure, and then the BIM model corresponding to the entity elements in all the visual guidance system in the tunnel is obtained based on the corresponding position of the entity elements in the tunnel. The BIM modeling tool is used to integrate the BIM model corresponding to the entity elements to obtain the three-dimensional tunnel model that can be imported into the graphics development engine, so that the three-dimensional tunnel model can complete the setting and rendering of relevant parameters.

### Embodiment 9

As an alternative embodiment, the dynamic evolution of the tunnel visual guidance system is realized in the three-dimensional tunnel model based on the adjustment of model parameters in the target BIM parametric geometric model library, including:

In the graphics development engine, the optical properties in the virtual tunnel scene are set and rendered based on the optical property information in the target BIM parametric geometric model; The optical property information at least includes the light source intensity, light source color, color temperature, color rendering, indirect light intensity, volume scattering intensity, BRDF (bidirectional reflection distribution function) parameter, reflective sign reverse reflection coefficient and typical texture mapping; The optical properties after rendering are adjusted to realize the dynamic evolution of each entity element in the tunnel vision guidance system, which speeds up the efficiency of modeling and improves the accuracy of simulation and simulation deduction results.

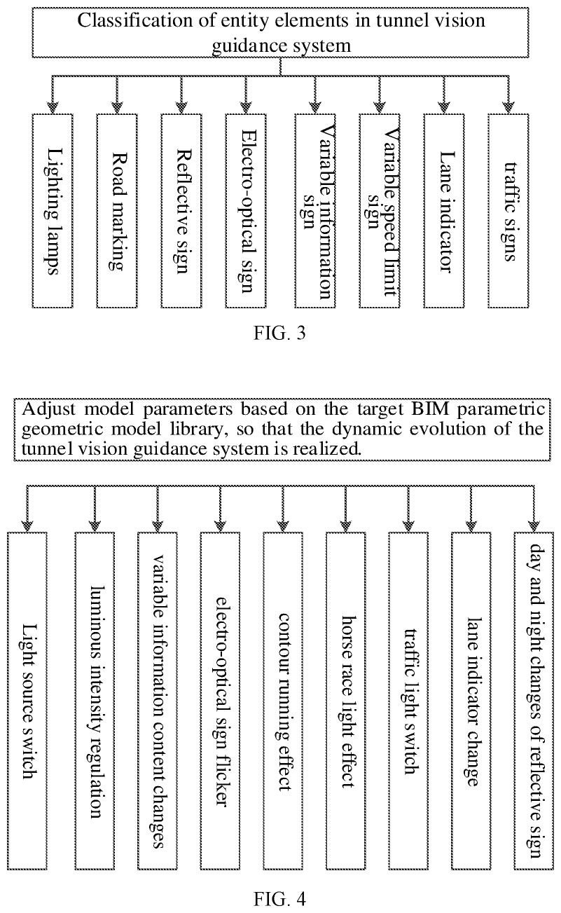

As shown in FIG. 4, adjusting the dimming coefficient, display color, traffic state, display content and other relevant parameters in the model, as well as the optical parameters related to real-time rendering, can not only improve the efficiency of parameter setting and the effect of real-time rendering, but also realize the dynamic evolution effect of lighting lamps switch, luminous intensity regulation, variable information display, flicker, horse race light, traffic light switch, lane indicator change and so on.

The luminous flux in the model parameters of entity elements of light source is used to assign the corresponding light source intensity in virtual reality. The display color and color temperature interval in the entity element model parameters of light source are used to assign the corresponding light source color in the virtual scene. The color rendering index in the entity element model parameters of light source is used to assign the color rendering degree of the color in the virtual scene. The minimum reverse reflection coefficient in the entity element model parameter of the reflective materials assigns value to the BRDF setting of the reflective mark line in the virtual scene, which is used to achieve the reverse reflection effect rendering of the reflective mark line in the virtual scene.

By adjusting the dimming coefficient in the entity element model parameters of the light source, the lighting lamps switch and luminous intensity regulation in the virtual tunnel scene are realized. When the parameter is 0, the lighting lamps is off, and when the parameter is 1, the lighting lamps outputs the maximum brightness, with linear interpolation in the middle. By adjusting the content of variable information sign and variable speed limit sign, the display content of variable information sign can be changed in virtual tunnel scene. By adjusting the dimming coefficient of multiple electro-optic signs deployed along the lane lines, tunnel walls or tunnel entrance contour marks, the flicker of electro-optic signs or marks, the light tracing effect of contour lines and running lights can be realized in the virtual tunnel scene. By adjusting the display color, display content and dimming coefficient of the signal light, the traffic light switch is realized in the virtual scene. By adjusting the traffic state and dimming coefficient of the lane indicator, the lane indicator can switch between traffic and no traffic.

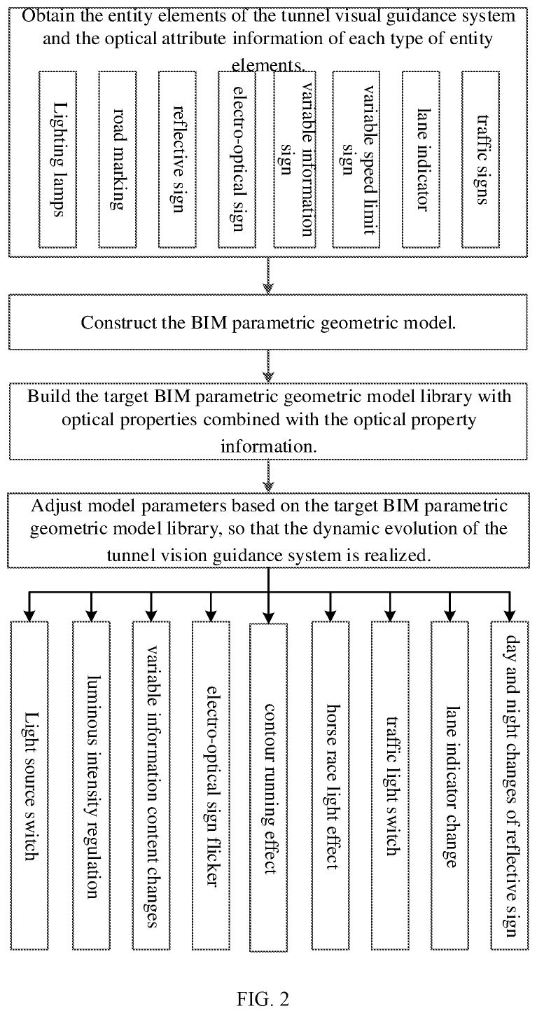

As shown in FIG. 2, the invention first classifies and analyzes the tunnel visual guidance entity elements, and obtains 8 categories of entities (including: lighting lamps, road marking, reflective signs, electro-optical signs, variable information signs, variable speed limit signs, lane indicators and traffic lights) and their corresponding geometric parameters; BIM parametric geometric model is constructed based on geometric parameters of entities; In the BIM parametric geometric model, the target BIM parametric geometric model library with optical attributes is obtained by combining the optical attribute information. BIM models of all required entity elements are obtained in the model library and integrated by BIM modeling tools. Then BIM models of all required entity elements are adjusted based on model parameters to complete the integrated construction and dynamic evolution of the data-driven tunnel visual guidance system.

### Embodiment 10

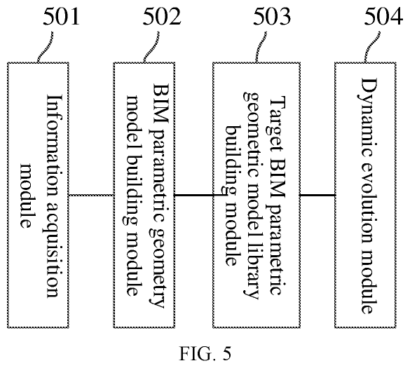

Based on the same idea, the invention provides a tunnel vision guidance system modeling and evolution device based on optical properties. As shown in FIG. 5, the device consists of:

The information acquisition module 501, which is used to obtain the entity elements of the tunnel visual guidance system and the optical attribute information of each type of entity elements. The types of the entity elements include light source and indication sign; The optical property information includes the type of light source, the brightness of light source, the color of light source, the display content of light source and the display degree of light source.

The BIM parametric geometric model building module 502. It is used to construct the BIM parametric geometric model of the entity elements according to the geometric parameters of the entity elements; The geometric parameter includes the contour information of the entity element.

The building module 503 of the target BIM parametric geometric model library, which is used to build the target BIM parametric geometric model library with optical properties based on the BIM parametric geometric model and combined with the optical property information of each type of entity element.

The dynamic evolution module 504. It is to adjust model parameters based on the target BIM parametric geometric model library, so that the dynamic evolution of the tunnel vision guidance system is realized; The model parameters are determined based on the geometric parameters and optical property information of each type of entity element.

Optional BIM parametric geometry model building module 502, includes: Geometric parameter acquisition unit, which is used to obtain the geometric parameters of each type of entity element based on the type of entity element. The light source in the type of the entity elements includes lighting lamps and traffic lights; The indication signs in the type of the entity elements include reflective signs, electro-optical signs, variable information signs, variable speed limit signs and lane indicators.

BIM parametric geometric model building unit. It is used to build the BIM parametric geometric model corresponding to each type of the entity elements according to the type and geometric parameters of the entity elements. Optional model parameter determination unit is specifically for: Determining the model parameters of the light source in the type of the entity element, including the model parameters of the lighting lamps and the model parameters of the traffic signs.

Determining the model parameters of the indicating sign in the type of the entity element, including the model parameters of the road marking, the model parameters of the reflective sign, the model parameters of the electro-optical sign, the model parameters of the variable information sign, the model parameters of the variable speed limit sign and the model parameters of the lane indicator.

The model parameters of the lighting lamps include the shape, contour size, type, luminous flux, luminous efficiency, color rendering index, color temperature interval, theoretical life and dimming parameters of the lighting lamps.

The model parameters of the traffic light include the radius of the traffic light, luminous flux, display color, dimming coefficient and display content.

The road marking model parameters include: road marking shape, contour size, type, color, reflective film type, minimum reverse reflection coefficient, daytime color and night color.

The model parameters of the reflective sign include the reflective sign shape, contour size, type, color, reflective film type, minimum reverse reflection coefficient, daytime color, night color and typical texture.

The model parameters of the electro-optical sign include: shape, contour size, category, illumination type, luminous flux, color rendering index, color temperature interval, dimming parameters and typical texture.

The model parameters of the variable information sign include: shape, contour size, luminous flux, color rendering index, color temperature interval, dimming parameter and text content of the variable information sign.

The model parameters of the variable speed limit sign include: variable speed limit sign shape, profile, luminous flux, color rendering index, color temperature interval, dimming parameter, speed limit value.

The model parameters of the lane indicator include: rectangular side length, LED luminous flux, number of LEDs on each side, traffic state and dimming coefficient of the lane indicator.

Optional target BIM parametric geometric model library building module 503, includes.

The optical property information determination unit, which is used to determine the optical property information corresponding to each type of entity element.

The optical property information addition unit, which is used to add the optical property information of each type of element to the BIM parametric geometric model corresponding to each type of entity element completed.

The standardized model building unit. It is used to build a standardized model corresponding to each type of entity element on the basis of a BIM parametric geometric model with optical properties.

The building unit of the target BIM parametric geometric model library, which is used to process the standardized model corresponding to each type of entity element to obtain the target BIM parametric geometric model library with optical properties.

Optional standardized model building units are specially for: Assigning value to each type of entity element; After the assignment, updating the BIM parameterized geometric model by the model parameters, to obtain the standardized model corresponding to the entity of each type of entity element.

Optional target BIM parameterized geometric model library building units, are specifically for: Adding semantic description to each standardized model, so that a preliminary model library is obtained. Coding the preliminary model library and organizing date to construct the target BIM parameterized geometric model library with semantic information and optical attribute information.

Optional dynamic evolution module 504, includes: The modeling parameter acquisition unit, which is used to obtain the modeling parameters of the vision guidance system in the real tunnel that is supposed to be modeled. The modeling parameters at least include: type of entity element, location of entity element and quantity of entity element; The three-dimensional tunnel model building unit, which is used to build a three-dimensional tunnel model based on the modeling parameters; The dynamic evolution unit of tunnel vision guidance system, which is used to realize the dynamic evolution of tunnel vision guidance system in the three-dimensional tunnel model based on the adjustment of model parameters in the target BIM parameterized geometric model library.

Optional three-dimensional tunnel model building unit is for: Constructing the main structure of the tunnel based on modeling parameters and using BIM modeling tool. At the corresponding position of the main structure of the tunnel, creating the BIM model corresponding to the entity elements of all the visual guidance system in the tunnel; Integrating BIM models corresponding to all solid elements in the visual tunnel guidance system in the BIM modeling tool to form a three-dimensional tunnel model that can be imported into the graphics development engine.

Optional tunnel vision guidance system dynamic evolution unit, is specifically for: In the graphics development engine, setting and rendering the optical properties in the virtual tunnel scene based on the optical properties information in the target BIM parametric geometric model; The optical property information at least includes light source intensity, light source color, color temperature, color rendering, indirect light intensity, volume scattering intensity, BRDF (bidirectional reflection distribution function) parameter, reflective sign reverse reflection coefficient and typical texture mapping; The parameters corresponding to the rendered optical properties are adjusted to realize the dynamic evolution of each entity element in the tunnel vision guidance system.

The above mainly introduces the scheme provided by the embodiment of the invention from the perspective of the interaction of each module. It is understood that in order to achieve the above functions, it contains the corresponding hardware structures and/or software modules to perform each function. Those skilled in the field should be easily aware that, in combination with the units and algorithmic steps of the examples described in the embodiment disclosed herein, the invention can be implemented in hardware or in a combination of hardware and computer software. Whether a function is performed in the way of hardware or in the way that computer software drives hardware depends on the specific application and design constraints of the technical solution. Technical professionals may use different methods to achieve the described functions for each particular application, but such implementation should not be considered beyond the scope of the present invention.

In spite that the present invention is described in conjunction with specific features and their embodiment, it is evident that various modifications and combinations may be made without deviating from the spirit and scope of the present invention. Accordingly, this specification and the accompanying maps are only exemplary illustrations of the invention as defined by the attached claims and are deemed to cover any and all modifications, variations, combinations or equivalents within the scope of the invention. Obviously, persons skilled in the field may make various alterations and variants of the present invention without deviating from the spirit and scope of the present invention. Thus, to the extent that these modifications and variations of the invention are within the scope of the claims of the invention and their equivalents, the invention is also intended to include such modifications and variation.

What is claimed is:

1. The modeling and evolution method of tunnel vision guidance systems based on optical attributes is characterized by:
the entity elements of tunnel visual guidance systems and the optical attribute information of each type of entity elements are obtained, where the types of the entity elements include light source and the indication sign; and
the optical attribute information contains the type of light source, the brightness of light source, the color of light source, the display content of light source and the display degree of light source;
according to the geometric parameters of entity elements, the BIM parameterized geometric model of entity elements is constructed; and
the geometric parameter covers the contour information of entity elements;
based on the BIM parameterized geometric model and the optical attribute information of each type of entity elements, a target BIM parameterized geometric model library with optical attributes is established;
model parameters are adjusted according to the target BIM parametric geometric model library to realize the dynamic evolution of tunnel vision guidance systems; and
the model parameters are determined based on geometric parameters and optical attribute information of each type of entity elements.

2. The modeling evolutionary method of tunnel vision guidance systems based on optical attributes mentioned in claim 1, is characterized by that the BIM parameterized geometric model of entity elements is constructed according to the geometric parameters of entity elements, including:
taking the type of entity elements as a dimension, the geometric parameters of each entity element are obtained;
the light source in the type of the entity elements includes lighting lamps and traffic lights;
the indication sign consists of road marking, reflective signs, electro-optical signs, variable information signs, variable speed limit signs and lane indicators among the type of entity elements;
according to the type of entity elements and the geometric parameters of entity elements, a BIM parametric geometric model corresponding to each type of entity elements is created.

3. The optical attribution-based modeling and evolution method of tunnel vision guidance systems described in claim 1, is characterized by that the model parameters are determined based on the geometric parameters and optical attribute information of various types of entity elements, to be specific:
the first model parameter of the light source in the type of entity elements is determined, which comprises the model parameters of light lamps and the model parameters of traffic lights;
the second model parameter of the indication sign in the type of entity elements is determined, which includes the model parameters of the road marking, the model parameters of the reflective sign, the model parameter of the electro-optical sign, the model parameter of the variable information sign, the model parameter of the variable speed limit sign and the model parameter of the lane indicator;
the model parameters of the light lamps involve the shape, contour size, type, luminous flux, luminous efficiency, color rendering index, color temperature interval, theoretical life and dimming parameter;
the model parameters of the traffic lights include the radius, luminous flux, display color, dimming coefficient and display content of traffic lights;
the model parameters of the road marking include the shape, contour size, type, color, reflective film type, minimum reverse reflection coefficient, daytime color and night color;
the model parameters of the reflective sign include the shape, contour size, type, color, reflective film type, minimum reverse reflection coefficient, daytime color, night color and typical texture;
the model parameters of the electro-optical sign include the shape, contour size, type, illumination type, luminous flux, color rendering index, color temperature interval, dimming parameter and typical texture;
the model parameters of the variable information sign include the shape, contour size, luminous flux, color rendering index, color temperature interval, dimming parameter and text content;
the model parameters of the variable speed limit sign include the shape, contour size, luminous flux, color rendering index, color temperature interval, dimming parameter and speed limit value;
the model parameters of the lane indicator include the rectangular side length, LED luminous flux, number of LEDs on each side, traffic state and dimming coefficient.

4. The modeling and evolution method of tunnel vision guidance systems based on optical attributes mentioned in claim 2, is characterized by that based on the BIM parameterized geometric model and combined with the optical attribute information of each type of entity elements, a target BIM parameterized geometric model library with optical attributes is built, including:
for each type of entity element, the corresponding optical attribute information is determined;
the optical attribute information in each type of entity elements is added to the BIM parametric geometric model corresponding to each type of entity elements completed;
based on the BIM parametric geometric model with optical attributes, a standardized model corresponding to each type of entity elements is constructed;
the standardized models corresponding to each type of entity elements are processed to obtain the target BIM parameterized geometric model library with optical properties.

5. The modeling evolution method of tunnel vision guidance systems based on optical attributes mentioned in claim 4, is characterized by that the standardized model corresponding to each type of entity elements is built on the basis of the BIM parametric geometric model with optical attributes, including:
the value is assigned to each type of entity elements;
after the assignment, the BIM parameterized geometric model is updated making use of the model parameters, and the standardized model corresponding to the entity of each type of entity elements is obtained.

6. The modeling and evolution method of tunnel vision guidance systems based on optical attributes described in claim 4, is characterized by that the standardized models corresponding to each type of entity elements are processed to obtain the target BIM parametric geometric model library with optical attributes, including:
semantic description is added to each standardized model to obtain a preliminary model library;
the preliminary model library is coded and organized with data, and the target BIM parameterized geometric model library with semantic information and optical attribute information is constructed.

7. The modeling and evolution method of tunnel vision guidance systems based on optical attributes mentioned in claim 1, is characterized by that the model parameters are adjusted based on the target BIM parameterized geometric model library to achieve the dynamic evolution of tunnel vision guidance systems, including:
the modeling parameters of the visual guidance system in the real tunnel are obtained, which at least include the type, location and quantity of entity elements;
based on the modeling parameters, a three-dimensional tunnel model is constructed;
based on the adjustment of model parameters in the target BIM parametric geometric model library, the dynamic evolution of tunnel vision guidance systems is realized in the three-dimensional tunnel model.

8. The optical attributes-based modeling and evolution method of visual guidance systems described in claim 7, is characterized by that the three-dimensional tunnel model is constructed based on the modeling parameters, including:
BIM modeling tool is used to construct the main structure of the tunnel based on modeling parameters;
at the corresponding position of the main structure of the tunnel, the BIM model corresponding to the entity elements of all the visual guidance system in the tunnel is constructed;
the BIM models corresponding to all entity elements in the visual guidance system in the tunnel are integrated in the BIM modeling tool to form a three-dimensional tunnel model that can be imported into the graphics development engine.

9. The modeling and evolution method of tunnel vision guidance systems based on optical attributes mentioned in claim 7, is characterized by that the dynamic evolution of tunnel vision guidance systems is achieved in the three-dimensional tunnel model based on the adjustment of model parameters in the target BIM parameterized geometric model library, including:
in the graphics development engine, the optical attributes in the virtual tunnel scene are set and rendered based on the optical properties information in the target BIM parametric geometric model; and
the optical attribute information at least includes light source intensity, color, color temperature, color rendering, indirect light intensity, volume scattering intensity, bidirectional reflection distribution function, as well as reflective mark reverse reflection coefficient and typical texture mapping;
the parameters corresponding to the rendered optical properties are adjusted to realize the dynamic evolution of each entity element in the tunnel vision guidance system.

10. The tunnel vision guidance system modeling and evolution device based on optical attributes is characterized by:
the information acquisition module is used to obtain the entity elements of tunnel visual guidance systems and the optical attribute information of each type of entity elements; and
the types of the entity elements cover light source and indication signs; and
the optical property information includes the type, brightness, color, display content and display degree of light source;
the BIM parametric geometric model building module is used to build the BIM parametric geometric model of the entity elements according to the geometric parameters of the entity elements; and
the geometric parameter includes the contour information of the entity element;
the building module of the target BIM parameterized geometric model library is used to build the target BIM parameterized geometric model library with optical properties based on the BIM parameterized geometric model and combined with the optical property information of each type of entity element;
the dynamic evolution module is used to adjust the model parameters based on the target BIM parametric geometric model library, so as to realize the dynamic evolution of the tunnel vision guidance system; and
the model parameters are determined based on the geometric parameters and optical property information of each type of entity element.
